(19) United States
(12) Patent Application Publication
(10) Pub. No.: US 2007/0122230 A1
(43) Pub. Date: May 31, 2007

(54) Versatile Drawing Utensil

(76) Inventor: George Lafayette JR., Baton Rouge, LA (US)

Correspondence Address: GEORGE LAFAYETTE, JR, 6458 NELLIE AVE., BATON ROUGE, LA, 70805, US

(21) Appl. No.: 11/599,775

(22) Filed: Feb. 5, 2007

Related U.S. Application Data
(60) Provisional application No. 60/737,757, filed on Nov. 18, 2005.

(51) Int. Cl. B43M 11/06; A47L 13/30

(52) U.S. Cl. 401/263; 401/261

(57) ABSTRACT

utensil is provided for applying drawing material such as pastel, charcoal, graphite, color lead to surface; and smoothing or blending drawing material while on surface; and then highlights afterwards. It comprises an elongate tubular housing with a pneumatic or electrical powered motor to activate mechanisms that causes an extended sway-arm at bottom to make oscillating or circular strokes which can allow richer drawing material to be applied to surface; or allow quicker blending and/or smoothing of the drawing material of the surface; or highlighting of the surface. It has interchangeable cartridges which consist of drawing material such as pastel, graphite, etc.; or smoothing and blending material such as tortillon or stump; or cartridge containing eraser for highlighting.

This patent application claims the benefit of the filing date of provisional patent Application No. 60/737,757, filed Nov. 18^{th}, 2005.

### FIELD OF INVENTION

This Versatile Drawing Utensil (VDU) relates to the means of shading in or coloring In with pastel, charcoal, graphite, colored leads; and blending and smoothing with stumps or tortillons; and highlighting with eraser when drawing.

### BACKGROUND

When an Artist draw pictures with pastel, charcoal, graphite, or colored leads, he normally sketch a light picture then apply pastel, charcoal, graphite, or colored lead by shading in or coloring in with hand using circular motions or oscillating motions. After applying pastel, charcoal, graphite, colored lead, the Artist normally blends and smooth the colors in by using a tortillon or stump or fmgers by making circular or oscillating strokes. After blending and smoothing, the Artist starts to highlight the picture with eraser using circular or oscillating motions.

When applying pastel, charcoal, graphite, colored lead, especially to large areas it can get tiresome to arm and/or hand by having arm elevated for a period of time; or when coloring or shading in small areas the artist sometime can't make deep short strokes and stay in the designated area; and coloring in a small area richly, requires accuracy and steadiness. Even when blending or smoothing pastel, charcoal, or graphite with tortillon or stump the arm and hand can get tired from making repetitive strokes.

This utensil has interchangeable snap-on cartridges which contain a segment of either pastel, charcoal, graphite, or colored lead; cartridge containing tortillon or stump; and cartridge containing eraser. It's a hand-held device that uses electric or pneumatic power to activate mechanisms of the device to apply color or shading to picture, and to blend and smooth the colors, and then highlight.

### SUMMARY

The object of this utensil is to help save time and energy and to give more accuracy. Instead of using the hand to color or shade in more richly and deeply, this utensil can save more time by applying richer coloring or shading more quickly because of the speed of the circular or oscillating strokes it provide and by saving time it saves energy by causing less manual work, like holding arm up for so long while applying color or blending and smoothing colors on drawing.

And in small areas this utensil can make rich coloring or shading with short strokes with going outside of designated area, because the artist unintentionally goes outside of the area when trying to make deep short strokes in small areas. This utensil applies deep, rich coloring or shading more accurately and more evenly.

Also when blending or smoothing the coloring or shading, this utensil saves time and energy. Instead of using present tortillon or stump or hand/or fingers to manually blend or smooth, this utensil contains a snap-on cartridge with built-on blender/stump that gives a better quality blending and smoothing much quicker than the hand.

It also has a cartridge with built-on eraser for making highlights on picture at higher speed, saving time and energy, with more accuracy. Instead of this eraser making rotating motion, it makes circular or oscillating motions.

This device makes working with pastel, charcoal, and graphite less messy, also. And it colors or shades, and smoothes or blends more evenly.

It also avoids having to press extra hard while trying to make rich coloring or shading which sometime causes pastel, charcoal, graphite, or colored lead to break. This device also allows more efficiency by allowing the artist to get the most out of the use of each pastel, charcoal, graphite, or colored lead.

### DESCRIPTION

In drawing of specifications,

FIG. 1 illustrates the way it may look.

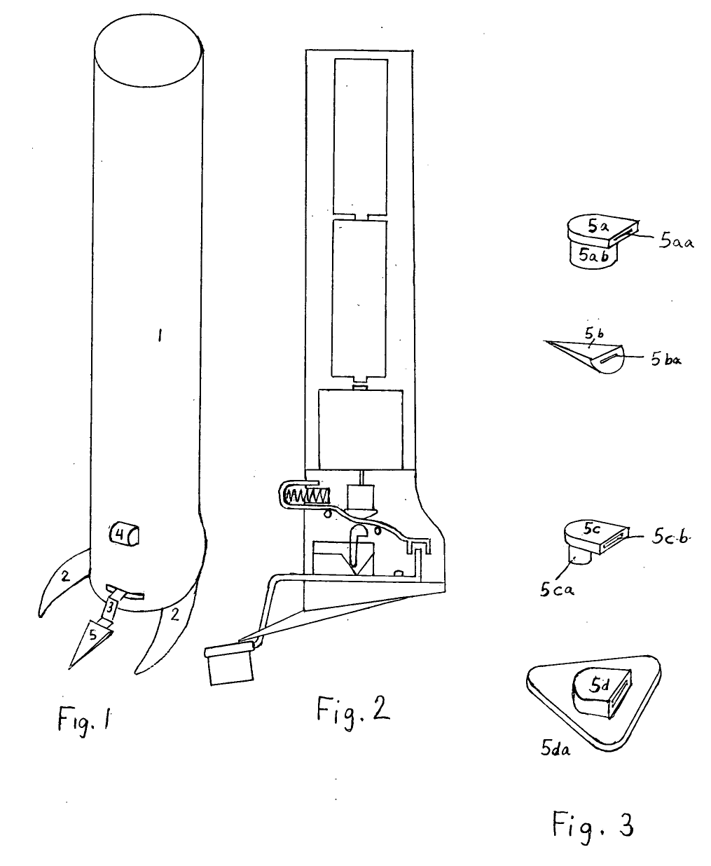

FIG. 2 illustrates a side view of how it looks on the inside.

FIG. 3 illustrates the different type of cartridges.

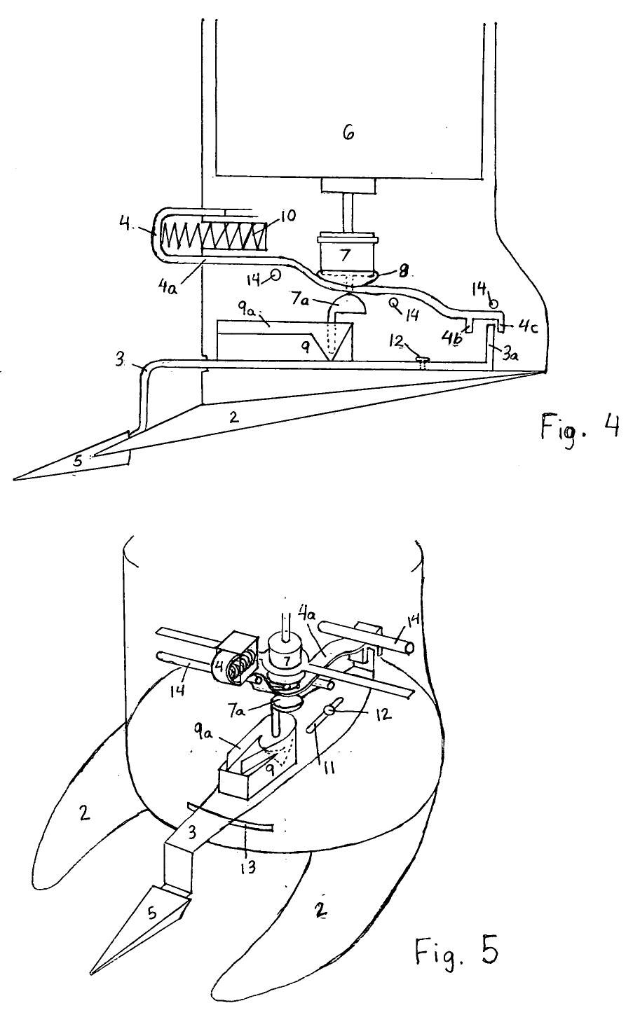

FIG. 4 is a close up side view of bottom end of utensil (main part).

FIG. 5 illustrates a perspective view of utensil.

The VDU device in this FIG. 1 illustrates how it looks. Shows the body (1) and levelers, (2) at the bottom on each side of sway-arm (3) to keep the sway-arm (3) leveled when in use. The button (4) near bottom is to be pushed or released when adjusting motion of sway-arm (3). The detachable cartridge (5) can be removed to be replaced, by another.

FIG. 2 is a small side view of utensil in which the inside is shown and a structure of how the parts are set up. Refer to FIG. 4 for a larger close-up view of the main part of utensil. It also shows how the batteries fit in the upper body, which is optional.

FIG. 3 illustrates the different cartridges, which fit snugly onto the sway-arm (3) of the utensil.

This is an illustration of the cartridge (5a), which contains a segment (5ab) of either pastel, charcoal, graphite, or color lead. The end of the sway-arm (3) fits snugly into the slot (5aa) of the cartridge (5a).

This is an illustration of a tortillon/stump cartridge (5b). The end of sway-arm (3) fits snugly into the slot (5ba). This is for blending and smoothing.

This is an illustration of the eraser cartridge (5c). It contains a segment (5ca) of eraser. The end of the sway-arm fits snugly into the slot (5fcb) of the cartridge (5c). This eraser cartridge is for highlighting.

This is an illustration of a larger blender/smoother cartridge (5d) for even larger areas. It holds a flat piece (5da) of material made of sponge, foam, fabric, paper or soft leather. It's often called a cot.

FIG. 4 illustrates the bottom, which is the main part of the utensil. It shows how the axle of motor (6) inserts freely in the cylinder (7) which turns with motor axle, but slide freely up and down the axle on the motor (6). The cylinder (7) is made with a gear (7a) attached to it. The cylinder/gear (7) runs through a bushing (8). The motor (6) spins cylinder/gear (7a) which latches in the funnel/slot (9) which is mounted sway-arm (3) which operates cartridge (5) in motion. The button (4) is part of the adjuster-arm (4a), it is used to adjust the motions of sway-arm (3) when pushed or released. When the button (4) is pushed, the adjuster-arm (4a) raises the rotating cylinder/gear (7a) higher up the funnel (9) so that sway-arm (3) can cause cartridge (5) to make shorter circular strokes, when released cylinder/gear (7a) goes back down which causes wider circular strokes. When button (4) is pushed further in, adjuster-arm (4a) lifts cylinder/gear (7a) higher and simultaneously the latch (4b) on end of adjuster-arm (4a) pushes the latch (3a) on sway-arm (3) causing sway-arm (3) to be pushed back so that rotating cylinder/gear (7a) can then set in elevated slot (9a) that's mounted on sway-arm (3) so that it can now make oscillating motions. The slot (9a) gets narrower towards its end. When sway-arm (3) is pushed further back the rotating gear (7a) then sets in narrower part of the slot (9a)causing the sway-arm (3) and cartridge (5) to make wider oscillating strokes. When button (4) is being released, the spring (10) pushes the adjuster-arm (4a) out causing the latch (4c) of arm (4a) to pull latch (3a) of sway-arm (3) simultaneously causing rotating gear (7a) to set in wider end of slot (9a) causing sway-arm (3) and cartridge (5) to make shorter oscillating strokes.

When released further latch (4c) will pull the latch (3a) of sway-arm (3) further in causing gear (7a) to now set in funnel part (9) of the sway-arm (3). The further out that adjuster-arm (4a) comes the deeper it allows rotating cylinder/gear (7a) to sink into funnel (9) causing sway-arm (3) and cartridge (5) to make wider circular motions. Adjuster-arm (4a) is shaped in a way that when pushed, it forces the rotating cylinder/gear (7a) up and when released it forces the gear (7a) down.

FIG. 5 is a perspective view of main part of the inside of utensil. It illustrates how the slot (11) allows for sway-arm (3) to be able to freely move forward or backward but held down with a peg (12) and still be able to make the oscillating or circulating motions. The slot (13) on the outer casing (1) also keeps the sway-arm (3) from rising up.

There are crossbars (14) used to support the adjuster-arm (4a) a crossbar (14) is placed under the beginning part of the adjuster-arm (4a). Another crossbar (14) is placed under the middle part of the adjuster-arm (4a). Another crossbar (14) is placed at top of ending part of adjuster-arm. Two levelers (2) are placed at bottom extending outward on each side of sway-arm (3) and cartridge (5) and sets just a little higher than cartridge (5). Te leveler (2) purpose is to keep sway-arm (3) and cartridge (5) leveled while in use.

The cartridge (5), which is contained of paste, charcoal, graphite, tortillon , stump or eraser, can snap on or off of sway-arm (3). The extended part of a sway-arm (3) is made in a way tat the cartridge (5) can fit snugly onto it with no slack.

I claim:

1. A utensil for applying drawing material such as pastel, charcoal, graphite, colored leads to a drawing. A utensil for blending or smoothing or highlighting a drawing, comprising; an elongated tubular housing approximately 6 inches in length and approximately ½ inch to 1 inch. It's made up of plastic or metal.

2. Comprising an electric or pneumatic powered motor attached on inside near bottom of said housing with rotating gear.

3. Rotating gear on axle of said motor is engaged into slot located on sway-arm of said housing. Said gear rotates inside said slot of sway-arm to cause oscillating or circular motions. Said sway-arm extends outward from bottom center of said housing.

4. Said sway-arm is made to hold an interchangeable cartridge which contains said drawing material, or tortillon or stump for blending or smoothing.

5. The motion of said sway-arm is controlled by an adjuster-arm which guides said sway-arm forward or back to be set to desired setting of oscillating or circular motions, short strokes or wide strokes.

6. Said slot on said sway-arm is wide on one end and gets narrower toward the other end for when said sway-arm is pushed forward or back by said adjuster-arm it can make short wide strokes.

7. Said adjuster-arm is connected to said sway-arm and extend to the outer part of said housing just above said sway-arm.
